(19) United States
(12) Patent Application Publication
(10) Pub. No.: US 2009/0054103 A1
(43) Pub. Date: Feb. 26, 2009

(54) PORTABLE COMMUNICATION DEVICE WITH AUTOMATED LOCALIZED CALENDAR

(75) Inventors: Bengt STAVENOW, Lund (SE); Claes KALLQVIST, Lund (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 11/938,955

(22) Filed: Nov. 13, 2007

Related U.S. Application Data
(60) Provisional application No. 60/956,736, filed on Aug. 20, 2007.

(51) Int. Cl. H04M 1/00

(52) U.S. Cl. 455/556.2

(57) ABSTRACT

A portable communication device, for example a mobile telephone, imports non-address information from a contact for use in communicating with the contact and/or planning or scheduling a calendar of one or more events, activities or the like. The non-address information may be imported to a local calendar in the portable communication device, and after use the information may be deleted to avoid polluting the local calendar. A method of importing information to a local calendar for use and deleting the information after it is not needed.

### CROSS-REFERENCE TO RELATED APPLICATION

This application claims the benefit of U.S. Provisional Patent Application Ser. No. 60/956,736, filed Aug. 20, 2007, the entire disclosure of which is hereby incorporated by reference.

### TECHNICAL FIELD OF THE INVENTION

The present invention relates generally to portable communication devices, and, more particularly, to a portable communication device and method of importing information for use and/or removing information with respect thereto.

### DESCRIPTION OF RELATED ART

In recent years, portable communication devices, such as mobile phones, personal digital assistants, mobile terminals, etc., continue to grow in popularity. As the popularity of portable communication devices continues to grow, today's wireless landscape is rapidly changing as mobile phones and networks are being enhanced to provide features and services beyond voice communications. The wireless industry is experiencing a rapid expansion of mobile data services. In addition, the features associated with certain types of portable communication devices have become increasingly diverse. To name a few examples, many portable communication devices have cameras, text and multimedia messaging capability, Internet browsing functionality, electronic mail capability, calendars, video playback capability, audio playback capability, image display capability, position sensing capability and hands-free headset interfaces.

With the rapid expansion of portable communication device functionality, users continue to make use of their portable communication devices for more and more communication activities.

### SUMMARY

One aspect of the technology relates to a communications method, including selecting a contact for communications including address information, importing temporarily non-address information pertaining to the contact and/or the intended communication, and employing the imported non-address information by at least one of providing the imported non-address information to a user intending to initiate communication with the contact and/or controlling the communication and/or assisting in the communication.

Another aspect relates to disposing of the temporarily imported non-address information.

Another aspect relates to importing temporarily the non-address information from a network.

Another aspect relates to importing temporarily the non-address information from a cached database.

Another aspect relates to the importing including importing personal information concerning the contact.

Another aspect relates to the importing personal information including importing birthday information.

Another aspect relates to the importing including importing habit information of the contact.

Another aspect relates to selecting a contact including address information comprising selecting a calendar and one or more dates.

Another aspect relates to the importing including importing habit information that includes at least one of communications patterns and/or vacation habits.

Another aspect relates to importing schedule information.

Another aspect relates to importing schedule information that includes importing holiday information at the local site of the contact.

Another aspect relates to obtaining presence information representing the location of the contact.

Another aspect relates to using presence information to determine the type of information to be imported.

Another aspect relates to selecting a contact for communications including selecting a contact for a meeting.

Another aspect relates to selecting a contact for a meeting including planning a calendar schedule.

Another aspect relates to selecting a contact including address information and wherein such selecting includes selecting a calendar and one or more dates.

Another aspect relates to selecting a contact for communications including making selection using a mobile telephone.

Another aspect relates to using a portable communication device to effect communications with a contact.

Another aspect relates to using a PDA.

Another aspect relates to communicating with a contact via text messaging or email.

Another aspect relates to said employing including displaying at least some of the imported non-address information.

Another aspect relates to removing at least some of the imported non-address information after having employed it.

Another aspect relates to the removing including removing all of such imported non-address information.

Another aspect of the present invention relates to a communications system, including a contacts database including contact identifiers of contacts, and contacting information usable to connect with a contact, a communication apparatus adapted to carry out communications from a user to communicate with a contact, a special information database, and a control adapted to provide temporarily to a user non-address information from the special information database pertaining to a contact with which communication is intended.

Another aspect relates a communications system wherein the contacts database includes an assemblage of contacts, including contact identifiers and contacting information usable to connect with a contact.

Another aspect relates to a communications system in which the contact identifiers include names of contacts, and the contacting information includes address information including at least one of telephone number, text message address or email address.

Another aspect relates to a communication system in which the special information database includes at least one of calendar information of the contact, other personal information of the contact, or habit information of the contact.

Another aspect relates to a communication system wherein the special information database includes geographical information associated with the contact.

Another aspect relates to a communication system wherein the special information database is adapted to receive information from a mobile telephone, PDA or computer of a selected contact.

Another aspect relates to a communication system wherein at least some of the imported non-address information is adapted to be deleted when communication with or attempt to communicate with a contact is concluded or inactive.

Another aspect of the invention relates to a method for communications using a communications apparatus, including in response to an input, identifying a contact with whom or with which a communication is intended, the contact having associated contacting information, and retrieving temporarily to the communications apparatus temporary information relevant to a communication with the contact other than the associated contacting information.

Another aspect comprises deleting the temporary information after no longer communicating with the contact or ceasing to attempt communicating with the contact.

Another aspect relates to using a communications device attempting to communicate with a contact, and said retrieving and deleting temporary information comprising retrieving temporary information to and deleting temporary information from a local calendar of the communications device.

Another aspect relates to using a communications device comprising using at least one of a mobile telephone, a non-mobile telephone, a computer or a PDA.

Another aspect relates to a method of scheduling including importing into a calendar a group of information having a given relationship, and providing at least some of such imported information for use, and subsequently removing the imported information from the calendar.

Another aspect relates to a method of scheduling wherein the providing at least some of such imported information comprising displaying at least some of the imported information in the context of the calendar, and the removing comprising removing all of the imported information that is not associated with a selected date.

Another aspect relates to a method of scheduling wherein the removing includes removing all of the imported information.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

Many aspects of the invention can be better understood with reference to the following drawings. The components in the drawings are not necessarily to scale, emphasis instead being placed upon clearly illustrating the principles of the present invention. Likewise, elements and features depicted in one drawing or embodiment of the invention may be combined with elements and features depicted in one or more additional drawings or embodiments. Moreover, in the drawings, like reference numerals designate corresponding parts throughout the several views.

### BRIEF DESCRIPTION OF THE DRAWINGS

In the annexed drawings:

FIG. 1A is a schematic illustration of a pair of mobile telephones capable of communications with each other directly or via a network;

FIG. 1B is a schematic illustration of a calendar;

FIG. 2 is a schematic block diagram of functional parts of a mobile telephone;

FIG. 3 is a schematic block diagram flow chart illustrating a method in accordance with the present invention;

FIG. 4 is a schematic block diagram of address information and non-address information and functions using such information;

FIG. 5 is a schematic block diagram flow chart illustrating an exemplary method of making a telephone call according to an embodiment of the invention; and

FIG. 6 is a schematic block diagram flow chart illustrating an exemplary method of planning communications, e.g., with respect to a calendar or schedule.

### DESCRIPTION

In the detailed description that follows, like components have been given the same reference numerals regardless of whether they are shown in different embodiments of the present invention. To illustrate the present invention in a clear and concise manner, the drawings may not necessarily be to scale and certain features may be shown in somewhat schematic form.

As used herein, the term “portable communication device” includes portable radio communication equipment. The term “portable radio communication equipment,” which may be referred to below as a mobile phone, a mobile device, a mobile radio terminal or a mobile terminal, includes all electronic equipment, including, but not limited to, mobile telephones, pagers, communicators, e.g., electronic organizers, smartphones, personal digital assistants (PDAs), or the like. While the present invention is being discussed with respect to portable communication devices, it is to be appreciated that the invention is not intended to be limited to portable communication devices, and can be applied to any type of electronic equipment capable of being used for voice and/or data communication.

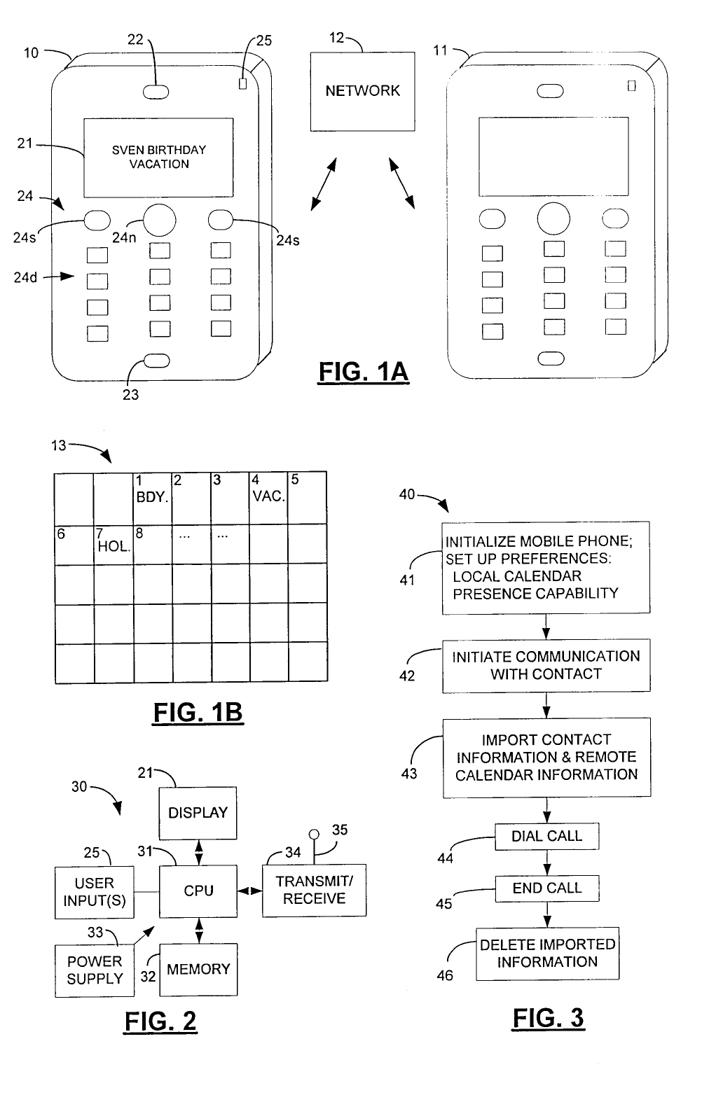

Referring to FIG. 1A of the drawings, a first user of a portable communication device 10 may intend to communicate with a second user of a portable communication device 11 via a network 12. For example, the portable communication devices 10, 11 may be mobile telephones. As is described below, address information, e.g., the telephone number or other address of the second user, and non-address information, e.g., calendar, holiday, habit, etc., may be used for the communication.

The non-address information may be helpful in one or more ways, several examples of which are described below. The non-address information may not be needed to place (or to make) a phone call or other connection, etc., but the non-address information may be retrieved or imported temporarily for use when it is needed. For example, the non-address information may be imported temporarily from a network, a cached memory or database, some other source or storage medium, or a remote location. The non-address information is removed when it is not needed. Therefore, retrieving or importing of non-address information may be referred to as temporary, e.g., as importing temporarily. By removing the non-address information when it is not needed, the mobile telephone memory and/or display components, for example, are not overloaded, e.g., in a sense they are not polluted, by information that no longer is needed.

The non-address information may be retrieved and imported to a calendar, for example, a local calendar in a portable communication device, in a computer, etc. In the description herein reference to local calendar, user's calendar, and user's local calendar may mean the same, e.g., a calendar or calendar function of a portable communication device, computer, etc., in which information that is related to one or more dates may be stored and can be retrieved for viewing or other use, as is described further below. The local calendar may be a calendar function and associated memory, etc. The non-address information may be deleted, removed, canceled, etc., from the local calendar after it no longer is needed. For example, the non-address information may be useful in making a telephone call or in planning for dates in a calendar or schedule for a meeting, vacation, etc.; and the non-address information may no longer be needed or may be otherwise inactive, e.g., after the telephone call has been ended and/or the calendar or schedule arrangements have been established.

For convenience one user of a mobile telephone, e.g., the device 10, may be referred to herein as “user” and another user of a mobile telephone, e.g., the device 11, may be referred to as “contact,” and the term “mobile telephone” may be referred to as “telephone.” As will be appreciated, the invention may be used with mobile telephones, other telephones, personal digital assistants (PDA), computers, other communication devices, etc.; for brevity, the invention will be described by way of example with respect to mobile telephones, but it will be appreciated that the invention may be used with other communication devices. It will be appreciated that although the invention is described with respect to communication in the nature of telephone calls, the invention also may be used with respect to other types of communication, such as, for example, text messaging, sending of emails, and planning for a communication, e.g., planning a schedule or calendar for various purposes.

Using the mobile telephone 10 the user selects a contact with whom the user desires to establish communication, e.g., by selecting a contact identifier, such as the name of the contact who is intended to be reached at the contact's mobile telephone 11. The contact may be selected in various ways, one example is to select a contact identifier, such as the contact's name, telephone number, code number or letters, etc., by pressing respective keys of the mobile telephone 10, scrolling through a list of names displayed on a display of the mobile telephone 10, etc. Information that may be relevant to the contact and/or the intended communication may be provided the user via the mobile telephone 10, e.g., address information, such as the telephone number of the contact; or the telephone number may be dialed automatically when the contact is selected, e.g., by scrolling to that contact or pressing a dial key while the contact's name is shown or highlighted, for example. Non-address information may be imported temporarily. The imported information may be non-address information. The imported information may be used in conjunction with the intended communication and/or during the communication. Address information may be, for example, the contact's one or more telephone number(s), messaging address(es), email address(es), etc., (also collectively sometimes referred to as contacting information or as address information).

One example of using imported non-address information to initiate or to control the communication may be to determine which of several telephone numbers of the contact is to be dialed. The imported non-address information may be obtained from or via a network, may be obtained from another storage location, e.g., a cached memory or database, or stored in a special information database of the mobile telephone of the user, etc., and may be used in several other ways to assist the communication, several examples of which are described below. When the communication has been ended or otherwise completed or concluded, e.g., disconnecting the connection to a contact's mobile telephone 11 or turning off the mobile telephone 10, etc., at least some of the imported non-address information is deleted from the mobile telephone 10 or at least is deleted from an active use and/or display component thereof.

Examples of imported non-address information may include one or more of the following: Calendar information, holiday information, habits, communication patterns, etc., some of which will be described further below. Examples of calendar information may be birthday, anniversary or other date-related information. It will be appreciated that other types of non-address information also may be imported for use in connection with initiating communication, controlling the communication and/or otherwise assisting in the communication. Non-address information may be information other than the telephone number of a contact.

In FIG. 1A two examples of imported non-address information for a contact, whose name, “Sven,” is shown on the display 21 of the mobile telephone 10, are that it is Sven's birthday and that Sven is on vacation. Knowing it is Sven's birthday, the user may commence a conversation with or message to Sven with a happy birthday greeting. Knowing Sven is on vacation, the user may understand where to reach Sven, e.g., what telephone number to dial, at what time to dial the number if the vacation place is in a different time zone from Sven's home or office, etc., and the user also may begin a conversation or message with wishes for a good vacation, etc.

Also, if desired, as an example of using non-address information to initiate or to control communication, the non-address information indicating that Sven is on vacation may be used to determine the telephone number (address information) that is to be dialed when trying to reach Sven. This may be carried out by the mobile phone 10 indicating, e.g., by displayed icon, message or the like, to the user which of Sven's telephone numbers should be dialed since he is on vacation. This also or alternatively may be carried out by the mobile telephone automatically dialing the correct telephone number for Sven based on the non-address information.

Communication may have a number of meanings. For example, communication may be the initiating of a telephone call from mobile telephone 10 to mobile telephone 11, or the continuing of the telephone call between those mobile telephones. These may be the electronic and radio functions of the mobile telephones alone or also including the network 12. Communication may be the connection of a mobile telephone or other portable communication device with a network. Communication may include a planning function, e.g., to plan a calendar for meeting or speaking with another person, for attending a function such as a concert, lecture, etc., for travel, for vacation, etc.

In FIG. 1B an example of one month of a calendar 13 is illustrated; several days have date numbers shown-other date numbers and the name of the month are omitted to avoid cluttering the drawing. The calendar 13 may be a local calendar included in the mobile telephone 10, and/or it may be a calendar in the mobile telephone 11; the calendar may be a computer function or program used in a computer, e.g., the Outlook calendar program sold by Microsoft Corporation, or the calendar may be part of some other system used in a personal computer, a personal digital assistant, or in some other computer, electronic device, or the like.

In an embodiment a contact may be a calendar, and address information of a calendar may be the date, e.g., the month, day, year and /or day of the week. The calendar may be used for planning, e.g., scheduling a meeting, a vacation, when to make a phone call, a social event, etc., or for other purposes. In the description below, reference to planning a calendar or scheduling a calendar may be used synonymously, e.g., to plan a schedule. In planning a calendar, e.g., scheduling, one or more dates and/or times on a calendar, a user may display the user's local calendar on a display, e.g., the display 21 of the user's mobile telephone 10 or the display associated with a computer, and may select dates of interest for a communication. The communication may be a meeting with another person, attendance at a function, vacation, etc. Planning or scheduling may include, for example, selecting a date (or date and time), writing the scheduled event into the local calendar, etc. Non-address information may be imported temporarily from a network, cached memory or database, etc., e.g., as was described above, into the local calendar to facilitate doing planning. When the planning has been completed, stopped, closed, etc., imported non-address information may be deleted from the local calendar or may be selectively saved for future use when reviewing a planned communication.

For example, the planned communication may be a user wanting to schedule a meeting with a selected person at a specific time and date, e.g., one or more days, weeks or months, etc. The selected person may be in a location, e.g., a country, different than the user. In response to indicating both calendar information, e.g., desired day, week, month, etc., in the local calendar and a selected person with whom the meeting may take place, e.g., that it is desired to schedule a meeting with the selected person, non-address information relevant to the selected person may be imported into the local calendar to be observed and considered by the user for use in determining whether or not to complete scheduling of the meeting. For example, the date intended by the user for a meeting with the selected person may be a public holiday in the country where the selected person is located, may be a religious holiday for the selected person, etc. In FIG. 1B a holiday is shown by the lettering “HOL.” By populating the local calendar with non-address information, which is relevant to the selected person, the user would learn which days may or may not be available for meeting with the selected person. For example, if the selected person is known to be in a given country, public holiday information pertaining to that country may be imported to the local calendar; and if the religion of the selected person is known, pertinent religious holidays also may be imported to the local calendar. After the user schedules the planned meeting in the local calendar, e.g., makes an entry in the local calendar, and concludes the planning, all or at least a portion of the imported non-address information that had been populated in the local calendar to facilitate the planning may be removed from the local calendar. Such removal may be carried out in a number of different ways; for example, automatically by software or other operation at the conclusion of the scheduling action or by the user providing an input, such as selecting an icon on a display, pressing a key, etc., thus avoiding polluting the local calendar or the like. The scheduled meeting may be retained in the local calendar, e.g., as usually is done so the user can find and/or be reminded of the scheduled meeting. Alternatively, the non-address information relevant to the scheduled date for the meeting may be retained in the local calendar without having to import it again so the user can see that non-address information when the local calendar is opened at another time, e.g., for review of forthcoming appointments, etc.

Various sources for the non-address information may be available. For example, non-address information may be available from a network, e.g., from a site accessible via the Internet, from a server, etc. Various calendar programs and databases are available for free and for purchase, e.g., those for different religious holidays, those with integrated holidays, etc. via the Internet. Non-address information may by available and imported from a cached database or other database that is in the mobile telephone or is retrieved from a remote source. Calendar programs, such as one available in the Microsoft Outlook software include a number of calendar functions, such as religious holiday information, etc. The non-address information may be obtained by entering the information, e.g., birthdays, anniversaries, holidays, etc., into a database that is stored in the mobile telephone or elsewhere and may be retrieved.,

As another alternative, the user may identify a selected person for a meeting and a desired date for the meeting on the user's local calendar. Non-address information relevant to that desired date and the selected person may be imported temporarily to the local calendar or in some way be displayed or otherwise presented to the user. For example, the desired date may be a holiday during which the selected person would not be expected to be working; and in this case the user may select a different date. The desired date may be the birthday of the selected person; and in this case the information may be a reminder to the user to send a birthday card or to bring a birthday gift to the meeting. In FIG. 1B a birthday of the selected person is designated on the local calendar by the lettering “BIRTH.” Also, if the selected person's local calendar is synchronized with the user's calendar, e.g., in advance or in the course of initiating a telephone call, and the selected person is on vacation on a particular day, the lettering “VAC.” may be displayed on the local calendar—alternatively or additionally the user's non-address information, e.g., the user's vacation or holiday schedule, may be shown on the local calendar. In the absence of space in the drawings, only an abbreviated form of the words birthday, holiday and vacation are shown and the name of the person to which that birthday, holiday or vacation applies is not shown; however, it will be appreciated that more information and fully written words may be provided on the display or the like of the mobile telephone, computer display, etc. or may be scrolled through for the presenting of more or less full information to the user. The information imported temporarily into the local calendar may be removed (erased/deleted) from the local calendar, may be retained in the local calendar until the meeting date has passed and then be removed from the local calendar, or may be saved in the local calendar for future reference. In an embodiment the imported non-address information may be removed as a group, e.g., all of the imported information may be removed at once. The removed information may be erased entirely from the local calendar or the like or it may be retained in an archive for subsequent retrieval as may be desired.

Sometimes a calendar becomes populated with so many information items that it becomes difficult to read the calendar and/or to find information of interest. For example, if a person has populated a calendar with information concerning local holidays in several countries or other jurisdictions, information concerning religious holidays of several different religions, personal information, such as birthdays, normal work hours, etc. of numerous persons, it is difficult efficiently to navigate intelligently through the calendar, e.g., to find clear dates for meetings, travel, vacations, etc. Also, as more information is stored in the calendar, more memory may be needed to store the information, as compared to a relatively smaller memory requirement for storing the information in an efficient database storage. Furthermore, time may be wasted to bring up or to display irrelevant information in a calendar on a portable communication device, computer display, etc. As an example, irrelevant information may be holidays in a country that is not of interest for the immediate communication planning, birthdays of persons that are not intended to be part of a communication, e.g., for a given meeting, etc. Using the present invention, non-address information used in connection with the phone call or local calendar planning, etc., for example, may be deleted from being displayed or otherwise used in connection with the phone call and/or planning and may be deleted from the calendar, but if desired the non-address information may be retained in a local database if desired, e.g., in the memory of the portable communication device, computer, etc. Such retaining of information in a local database may be is more efficient than maintaining it in a calendar format; and removing irrelevant information from being shown in a calendar also ordinarily would make reviewing the calendar more clear and efficient.

Using the present invention efficient use is made of memory and time in carrying out calendar functions. Enhanced efficiency and functionality, for example, also may be provided the portable communication device communication functions.

Referring to FIGS. 1A and 2, the mobile telephones 10, 11 may be conventional mobile telephones with added functionality and/or computer program type software as described herein. Reference to computer program software refers to various steps that may be carried out using a computer, using the electronics in a mobile telephone, in some other telephone, in a PDA, etc. or using some other device. The network 12 may be conventional. The mobile telephone 10 may include a case 20, display 21, speaker 22, microphone 23, and keys 24. The keys 24 may include dialing and function keys 24d, e.g., numbers 1-9, 0, * and #; soft switch keys 24s; and navigation and selection key 24n. The keys may be used in conventional manner to provide inputs to the mobile telephone, e.g., telephone numbers, functions selection, alphanumeric inputs, etc. The mobile telephone may include a power switch/on-off switch 25 and also may include one or more other keys, devices, etc. The display 21 may be a liquid crystal display (LCD), light emitting diode (LED) display or another type of display. The display 21 may be capable to provide alphanumeric information of one or more alphabets, symbols and/or numeral representations, for example, to be read and understood by a user. The display 21 also may include one or more icons that can be shown to represent a particular condition, such as, for example, whether a contact, who is intended to be dialed or called by a user, is available to receive a telephone call—e.g., is the contact's telephone powered on and is it within range of a suitable communications network to receive telephone calls. The icons also may be used to present other information to a user, e.g., whether the telephone number selected to be dialed is the home, office or mobile telephone number of the contact. The icons may be used to indicate other information.

In FIG. 2 in system block diagram form is illustrated an example of a functional system 30 that may be used in the mobile telephone 10. The system 30 of the mobile telephone 10 includes a central processor unit (CPU) 31, memory 32, power supply 33, transmitter/receiver 34, and antenna 35 as well as display 21 and keys 24 (or other user inputs). The system 30 may operate in the mobile telephone 10 in conventional manner. For example, the power supply 33 provides electrical power to the system 30; keys 24 may provide inputs to the CPU 31, and in response to programming and/or data in the memory 32 and/or inputs from the transmitter/receiver 34 via the antenna 35, for example, the system 30 provides for operation of the mobile telephone 10. Examples of such operation include receiving, initiating and otherwise carrying out telephone calls, e.g., voice data, receiving and transmitting text messages, connecting with the Internet and carrying out functions therewith, operating the display, calendar functions, etc.

Additionally, the system 30 may operate to carry out the various functions described above, e.g., to import temporarily information pertaining to a contact, e.g., non-address information, employing or allowing to be employed that imported information, and removing the imported information while still permitting some or all of the information to remain in a desired database.

FIG. 3 illustrates a relatively high level functional block diagram or computer program flow chart 40 representation of the invention as used in a portable communication device or the like, e.g., those shown at 10, 11 in FIG. 1. It will be appreciated that the steps represented in the several blocks illustrated and described with regard to FIG. 3 and the other drawing figures hereof may be carried out using computer program software for operating a mobile telephone or other device with which the invention may be used. A person who has ordinary skill in the art would be able to write suitable computer program code in a computer program language appropriate to the mobile telephone or other device in which the invention may be carried out thereby to practice the invention.

In the flow chart 40 of FIG. 3 at step 41 the mobile telephone, e.g., the mobile telephone 10, is initialized, e.g., turned on and the circuits and functions thereof set up as desired by the user. At step 41 part of the initializing steps include establishing a local calendar, e.g., assuring that the calendar function in the mobile telephone is available and the functions thereof are operational, e.g., to present not only days, months and years but also, if desired, to present previously scheduled appointments, reminders, and the like. Setting up the local calendar also may include turning on the calendar function to the extent that it can respond to date-related imported information from the telephone being called, e.g., mobile telephone 11 (FIG. 1A). For convenience of description the mobile telephone 10 may be referred to as the calling telephone and the portable communication device 11 may be referred to as the called or receiving telephone.

Also, if the mobile telephones 10, 11 and the associated network 12 have presence capability, the user may set up preferences of the mobile telephone to allow for presence detection or not. Various presence detection functions may be possible, depending on the telephones 10, 11 and the network 12. For example, presence information may be simply permitting the mobile telephone to be located for an incoming telephone call; this function may be geographically restricted, e.g., allowing the mobile telephone to be located while in the user's and telephone's home country, but not allowing the mobile telephone to be found or located if out of the home country, out of a state or city of the country, etc. Presence information also may be an indication that the user of the mobile telephone desires privacy to block some or all incoming phone calls and/or messages. Presence information also may be used to indicate to a calling party that the receiving party is busy, e.g., in a meeting, driving at a place where telephone calls are not permitted while driving, that the receiving party is on vacation, or that it is a holiday and the receiving party currently is not responding to telephone calls, etc. Setting up presence information also may be the setting up of a capability for the user's mobile telephone to respond to presence information that it receives from a called telephone.

At step 42 the user initiates communication with a contact. This may be carried out in various ways. For example, the user may select a contact to be called from a list of contacts in the mobile telephone 10. The list of contacts may be stored, for example, in the memory 32; and the user may scroll through the contacts as they are shown on display 21 to find and to select the desired contact or otherwise may select a contact, e.g., by dialing the contact's telephone number. Selecting the contact also may bring up address information pertaining to the contact, such as the contact's telephone number(s), email address(es) or some other address information pertaining to the contact.

Upon selecting the contact, e.g., by pressing the selection key 24n or some other key 24, then at step 43 non-address information relevant to the contact is imported from the user's contacts database and is presented on the display 21 for viewing and possible use by the user. Such non-address information may indicate that today is the contact's birthday. Non-address information also may be imported from the user's local calendar or from the contact's own calendar. For example, the contact's non-address information may be imported from the contact's calendar in the contact's mobile telephone or, if permitted by the contact, from the contact's home or office computer, etc., e.g., via a network connection or some other means. For example, the contact's calendar may be available to the user, who may import (download) part or all of the contact's calendar to the user's mobile telephone 10. Such imported non-address information also may indicate the location of the contact, that the contact is on vacation, etc.

Non-address information may be drawn from a type of presence information or other signal from the contact's phone. For example, presence information may indicate that the contact's phone is on but the contact does not want to be disturbed, e.g., unless for an emergency, because the contact currently is involved in a business meeting. Another type of presence information may be the current location of the contact, e.g., is the contact at home, at the office, out of the country, etc., and this non-address information can be used to identify which telephone number should be dialed to reach the contact.

If the non-address information of the contact is to be imported from the contact's mobile telephone and it cannot be obtained and imported without first somehow communicating with the contact's phone, e.g., by dialing the contact's telephone number, then such information may be obtained after the telephone number is dialed and connection is made with the contact's phone. The non-address information may be displayed to the user while the telephone is ringing on the contact's mobile telephone or may be imported from the contact's telephone after connection has been made with the contact's mobile telephone and prior to ringing or other signaling on the contact's mobile telephone.

If presence or other information indicates that the contact is occupied and does not want to be disturbed, the user's mobile telephone 10 may receive that information and indicate the same by displaying an icon on the user's mobile telephone display 21. If the presence or other information indicates that the contact is in a different country, the information may be used by the user's mobile telephone to assure dialing of the appropriate country code and/or telephone number format (some dialing systems require an extra digit when dialing within a country but not when using a country code to dial from outside the country, etc.), while dialing the contact. Such assurance may be automatically carried out by the user's mobile telephone when the contact's telephone number is dialed automatically by pressing a dial key, or it may be some other signaling to the user while manually dialing. Further, if the presence or other information indicates from calendar information that it is a holiday, non-work day, vacation day, etc., such information may be used automatically by the user's mobile telephone or by the user to be sure to dial the appropriate telephone number of the contact, e.g., a home or vacation telephone number rather than an office telephone number.

At step 44 the contact's telephone number is dialed. As was mentioned above, the dialing function may be carried out during part of or prior to step 43 being carried out. Dialing also may be the sending of a text message, transmitting a photograph, connecting to the Internet and sending an email, etc.

If the contact's mobile telephone is answered, a telephone conversation may be carried out between the user and contact. At the end of the conversation or if the contact does not answer, then at step 45 the call is ended.

At step 46 the imported non-address information is deleted from the user's mobile telephone. In this regard, the imported non-address information that was retrieved from a local database in the user's portable communication device may be retained in that local database, e.g., birthday information pertaining to the contact or holiday information, but the imported non-address information may be deleted from the calendar display and/or the general display and its driving circuitry, memory, buffers, etc. of the user's mobile telephone. The information imported from the contact's telephone may be deleted unless specifically saved.

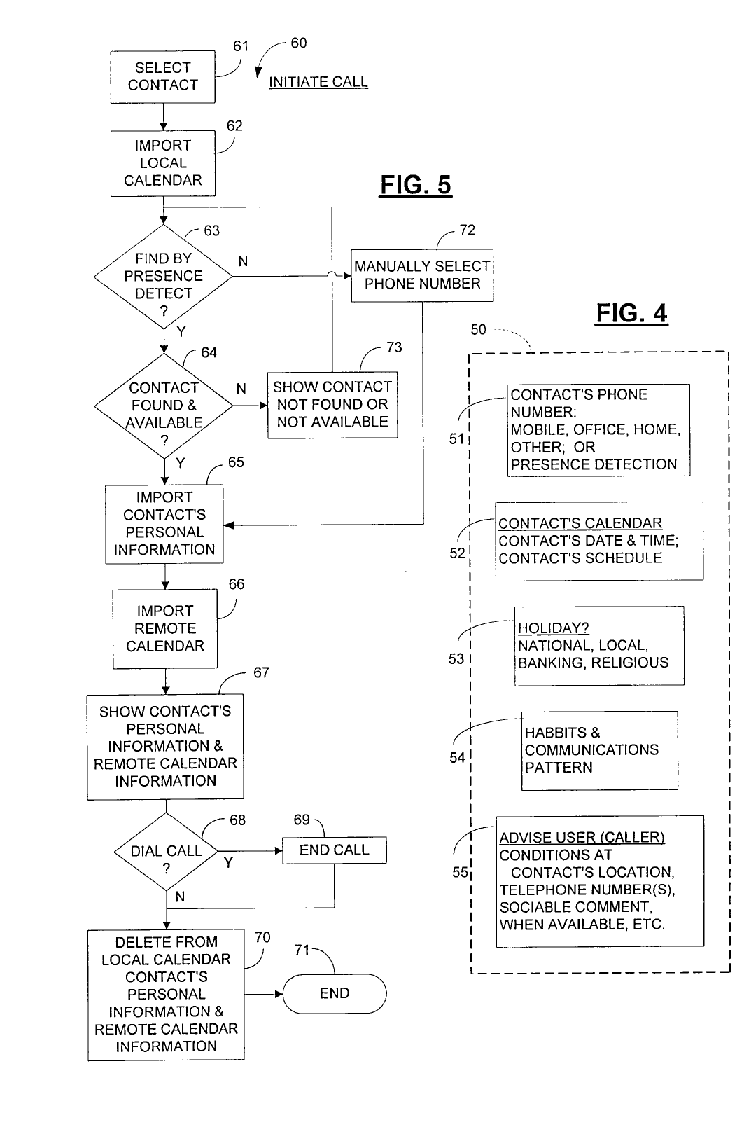

Turning to FIG. 4, which expands on step 43 of FIG. 3, information pertaining to a contact is illustrated collectively at 50. The information in FIG. 4 is exemplary; other information may be provided in addition to or in place of some or all of the illustrated information.

Step 50 represents the relationship of address information at step 51 and non-address information at steps 52-54. Presence information, which may be considered non-address information, as was described above, may indicate the location of the contact and provide the user with the best telephone number at which to reach the contact at the moment, if the contact has not disabled presence detection function of the contact's phone. The presence information may represent the current location of the contact and the date and time at that location.

With the address information known, non-address information may be imported to the user's mobile telephone, such as, for example, to the local calendar of the user's telephone, as is generally indicated at step 52 in FIG. 4. The non-address information may include the date and time at the location of the contact and the contact's schedule, e.g., from the contact's calendar. With information known as to the location of the contact and the date and time there, then at step 53 other non-address information may be imported to the user's telephone, such as, for example, holiday information. Holiday information may be whether there is a national, local, or bank holiday, etc. at current the location of the contact. Such holiday information also may indicate whether the day is a religious holiday that may be pertinent to the contact—the religious holiday may be one generally celebrated by a large portion of the local population in the given location or may be a holiday celebrated by the contact but not generally by the local population in the given location, and the type of holiday may be appropriately indicated to the user on the display 21 by a message or icon, for example.

Habits and communications pattern (step 54) of the contact also may be imported to the user's mobile telephone. These may be drawn from the contact's mobile telephone, e.g., as part of a presence information authorization setup, from calendar information in the contact's mobile telephone, or specifically stored information in the contact's mobile telephone memory for use by callers. Habit information may include the contact's usual work hours, lunch time, bedtime, weekend work hours, etc. Communications pattern may include, for example, the time of day when the contact does not want to receive telephone calls, e.g., the contact may be a surgeon who performs surgery on specified days and times each week and does not want to be disturbed or the contact may not want to receive business phone calls during lunch hour.

One or more of the foregoing and other non-address information may be imported to the user's mobile telephone for use and/or so the user can understand and make use of the contact's availability information and/or and other information pertaining to the contact.

As is seen at step 55, the imported information is provided to advise the user of that information for appropriate use. Accordingly, as examples, the user would be aware of conditions at the contact's location, such as date and time, whether at home, office, on vacation, etc., the appropriate telephone number where most efficiently to reach the contact, social comment (e.g., to extend a birthday or anniversary greeting), and, if the contact is not available, when the contact may be expected to be available to receive a telephone call (e.g., based on appointment information in the contact's calendar).

Referring to FIG. 5 an example of a communications method as a process, method or routine of steps or functions to carry out making a phone call in accordance with an embodiment of the invention is illustrated at 60. The phone call is initiated at step 61 by a user scrolling through the contacts database in the user's mobile telephone and selecting a contact or by dialing the contact's telephone number or a code for the contact's telephone number, for example. The navigation/select key, e.g., 24n or one of the soft switch keys 24s, may be pressed to complete selecting the contact. As an alternative the selecting may be completed by scrolling to the contact and not scrolling further, whereby after a duration of time, e.g., as determined by a timer in the mobile telephone, the selection would be complete. At step 62 the user's local calendar is imported to provide current date and time and any relevant non-address information that may have been stored previously regarding the contact and/or the current date and/or time, e.g., the contact's birthday, wedding anniversary, university graduation day, etc.

At step 63 an inquiry is made whether the contact is to be found by a presence detector so that the contact's mobile telephone number would be dialed or such other appropriate telephone number of the contact would be dialed, e.g., a home telephone number, office telephone number, vacation home telephone number, or the mobile telephone number as modified to be accessed in a different country, etc. If the answer at step 63 is yes, then at step 64 an inquiry is made whether the contact has been found and is available to receive a telephone call from the user.

If at step 64 the answer is yes, the contact was found and available, then at step 65 personal non-address information of the contact is imported to the user's mobile telephone, e.g., as was described above. At step 66, the contact's calendar (sometimes referred to as “remote calendar” as it is not initially in the user's mobile telephone) or a relevant part of the remote calendar, is imported to the user's mobile telephone, e.g., to the user's local calendar. Such imported remote calendar relevant information may be information of the contact for the current day or, if desired, may be for more than one day. Such remote calendar information and other personal non-address information provides assistance to the user to know, for example, whether to extend birthday or other wishes when making the telephone call and also may assist the user in determining the location of the contact, whether or not the contact is available to receive telephone calls and if not, when the contact is likely to be available to receive telephone calls, etc. Therefore, at step 67 the contact's personal information and remote calendar information, which were obtained at steps 65 and 66, and any other relevant information pertaining to the contact and/or the anticipated telephone call to the contact may be shown to the user, e.g., via the display 21, via sounds and/or vibrations, via one or more icons, etc. Such information may be shown in the context of a display of the user's local calendar or may be listed on the display 21, for example.

At step 68 an inquiry is made whether the user has dialed the telephone call to the contact. If yes, then the call may be carried out, and after conversation between the user and contact has been concluded or if the contact's telephone is busy, the call may be ended at step 69, e.g., by the user pressing a call end key on the mobile telephone 10, for example. If the call is not dialed at step 69 or if the call is ended at step 69, then at step 70 the imported information is deleted from the user's local calendar, such as, for example, the contact's non-address personal information and remote calendar information. The call process including the call itself and the deleting of information at step 70, is ended at step 71.

Referring back to inquiry step 63, if the answer to the inquiry is no, i.e., it is not intended to try to find the contact by presence detection, then at step 72 the contact's mobile telephone number may be dialed manually by the user. After manual dialing, the method or process continues at step 65.

Referring back to inquiry step 64, if the answer to the inquiry is no, i.e., the contact was not found or the contact was not available, e.g., due to a privacy setting on the contact's mobile telephone, then at step 73 an indication on the user's mobile telephone, e.g., an icon or other indication or wording on the display 21, would show that the contact had not been found or is not available. At that point the process flows back to step 63, as is illustrated. At this point or at any other point in the process 60, the user may terminate making the telephone call by pressing an end key, e.g., as is indicated at step 71 or by otherwise terminating the phone call.

It is noted that non-address information may be imported from the contact to the user's mobile telephone prior to dialing a call to the user at step 68. It will be appreciated that the contact's telephone in a sense may be polled by the user's telephone prior to actually completing making the telephone call. For example, upon selecting the contact, the user's telephone may connect with the contact's telephone to import information, e.g., by dialing the contact's telephone and connecting with it for the purpose of importing information but without indicating to the contact that a telephone call is being made to his/her telephone. Thereafter, the user may press a call button, e.g., a soft switch 24s or the navigate/select switch 24n, etc., while the contact's name is selected, e.g., showing in the display 21, thereby to complete making the telephone call to the contact to speak with the contact.

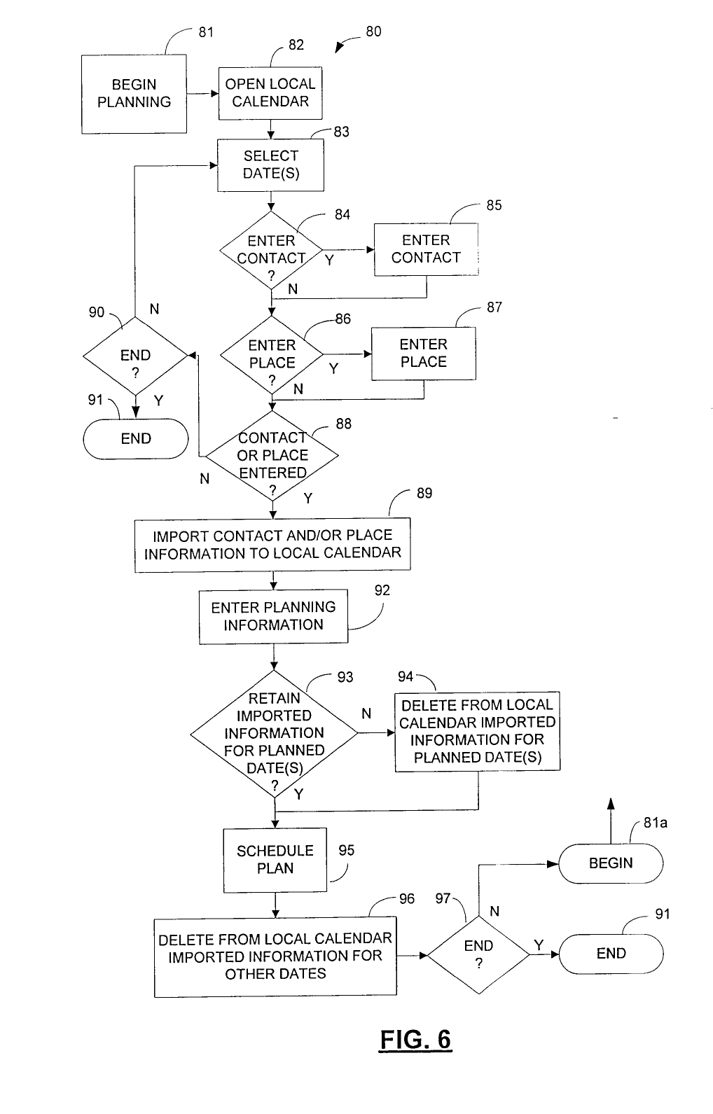

Referring to FIG. 6 an example of a communications method as a process, method or routine of steps or functions to carry out planning a calendar of meeting at a specified time and place and possibly with a known contact about whom information may be available or accessible to the user in accordance with an embodiment of the invention is illustrated at 80. The planning may be carried out using a mobile telephone that has a local calendar; the planning may be carried out using a PDA, or a notebook, desktop, or other computer, etc. As an example, planning may be carried out using a calendar program, such as, for example, a calendar or scheduling program that is provided in the Outlook® computer software sold by Microsoft Corporation.

At step 81 planning is begun, e.g., by starting the computer software needed to carry out the following steps using a mobile telephone, computer, etc. At step 82 the local calendar of the user is opened, for example, to be reviewed, considered in the planning, and/or to be edited to insert or to remove dates, appointments, etc. At step 83 one or more dates is/are selected in the local calendar, e.g., a single day, several days, a week, a month, etc. At step 84 an inquiry is made whether the user desires to enter a contact with whom the user plans to have a meeting or otherwise to share in an activity, etc. If the answer is yes, then at step 85 the user enters in the mobile telephone, PDA, computer, etc., information to identify the contact; for example, the user may scroll through a list of contacts from memory that is shown on the display and may select the desired contact; the process then goes to step 86. If the answer is no at step 84, then the process goes to step 86 at which an inquiry is made whether the user wants to enter a place where a meeting may take place. If the answer at step 86 is yes, then at step 87 the place is entered in the computer, mobile telephone, etc.

If only a place is entered at steps 86, 87, but no contact is entered at steps 84, 85, then the planning may be to attend a meeting, to go on vacation, etc., without concern for arrangements with other contacts, and the answer at step 84 may be no but the answer at step 85 may be yes. Similarly, if it were desired to meet with a contact, but the place of the meeting initially is not of concern, then at step 84 the answer may be yes and the answer at step 86 may be no.

As will be appreciated, although steps 84 and 86 pertain to entering a contact or a place, other inquiries and entries can be made, such as, for example, to perform a task, to commence a trip, to schedule a meeting, vacation, etc., and so on.

At step 88 an inquiry is made whether at least one contact or at least one place had been entered at steps 84, 85 and/or at steps 86, 87. If the answer is yes, then at step 89 the contact and/or place information is imported to the local calendar of the user. The imported contact information may include non-address information and/or may include address information, examples of both having been described above.

At step 88, if the answer is no, i.e., no contact or place information had been entered, then the process moves to step 90 where inquiry is made whether the user wants to end or to continue the process. If the answer is yes, i.e., to end the process, then the process moves to step 91 and the process ends. If the answer at step 90 is no, i.e., the user desires to continue the planning process, then the process returns to step 83 and continues as described above and below.

Following step 89, planning information is entered at block 92. Planning may be to enter in the local calendar or another database information pertaining to one or more of the place, date, time, subject matter of a meeting, personal information about a contact, hotel information, travel information, etc.

At step 93 an inquiry is made whether the user desires to retain imported information for planned date(s). For example, some of the imported information may be irrelevant. Perhaps the contact does not want anyone to recognize his/her birthday, or the user only is authorized to use one of several email addresses for writing the contact for the purpose of the subject meeting, etc., and, therefore, it may be desired to retain or not some or all of the imported information. If the answer at inquiry step 93 is no, then at step 94 some or all of the imported information is deleted from the user's local calendar for the planned date(s). If the answer at inquiry step is yes, the imported information should be retained for the planned date(s), then the process flows to step 95 and the meeting or other plan, e.g., the communication intended, is scheduled. At step 96 imported information for other dates is deleted from the local calendar so as not to “pollute” the local calendar. As was mentioned above, such deleting avoids including in a calendar extraneous information that is unnecessary for the user and may make it difficult to find and/or to keep track of important events.

At step 97 an inquiry is made whether the user desires to end the process of this communication, e.g., planning an event at which communication, vacation, task, etc., may occur. If the answer is no, then the process returns via step 81 a to step 81 to continue the planning process. If the answer at step 97 is yes, to end the process, then the process ends at step 91.

It will be appreciated that a mobile telephone equipped with the non-address information importing and deleting capabilities may be used to provide information to a user as needed and to delete the information to avoid polluting the user's mobile telephone.

As will be appreciated by one of skill in the art, computer program elements and/or circuitry elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A communications method, comprising
selecting a contact for communications including address information,
importing from a network, cached memory, or remote device non-address information pertaining to the contact and/or the intended communication,
employing the imported non-address information by at least one of providing the imported non-address information to a user intending to initiate communication with the contact and/or controlling the communication and/or assisting in the communication.

2. The method of claim 1, said importing comprising importing non-address information as at least one of information pertaining to presence, birthday, habit, holiday or calendar, and wherein the address information comprises at least one of telephone number, email address, text messaging address, or other address at which the contact may be reached.

3. The method of claim 1, said importing comprising importing at least one of personal information concerning the contact or habit information of the contact.

4. The method of claim 1, further comprising importing schedule information.

5. The method of claim 4, said importing schedule information comprising importing holiday information at the local site of the contact.

6. The method of claim 1, further comprising obtaining presence information representing the location of the contact, and using presence information to determine the type of information to be imported.

7. The method of claim 1, said selecting a contact for communications comprising selecting a contact for a meeting, and said selecting a contact for a meeting comprising planning a calendar schedule.

8. The method of claim 1, said selecting a contact including address information comprising selecting a calendar and one or more dates.

9. The method of claim 1, said selecting a contact for communications comprising making selection using a mobile telephone or PDA, and using the mobile telephone or PDA to effect communications with a contact.

10. The method of claim 1, said employing comprising communicating with the contact via text messaging or email.

11. The method of claim 1, said employing comprising displaying at least some of the imported non-address information.

12. The method of claim 1, further comprising removing at least some of the imported non-address information after having employed it.

13. The method of claim 12, said removing comprising removing all of such imported non-address information.

14. A communications system, comprising
a contacts database including contact identifiers of contacts, and contacting information usable to connect with a contact,
a communication apparatus adapted to carry out communications from a user to communicate with a contact,
special information database, and
a control adapted to provide temporarily to a user non-address information from the special information database pertaining to a contact with which communication is intended.

15. The communications system of claim 14, said contacts database comprising an assemblage of contacts, including contact identifiers and contacting information usable to connect with a contact, said contact identifiers comprising names of contacts, and said contacting information comprising address information including at least one of telephone number, text message address or email address.

16. The communication system of claims 14, said special information database comprising at least one of calendar information of the contact, other personal information of the contact, or habit information of the contact.

17. The communication system of claim 14, said special information comprising geographical information associated with the contact.

18. The communication system of claim 14, said special information database being adapted to receive information from a mobile telephone, PDA or computer of a selected contact.

19. The communication system of claim 14, wherein at least some of the imported non-address information is adapted to be deleted when communication with or attempt to communicate with a contact is concluded or inactive.

20. A method for communications using a communications apparatus, comprising
in response to an input, identifying a contact with whom or with which a communication is intended, the contact having associated contacting information, and
retrieving temporarily to the communications apparatus temporary information relevant to a communication with the contact other than the associated contacting information.

21. The method of claim 20, further comprising deleting the temporary information after no longer communicating with the contact or ceasing to attempt communicating with the contact.

22. The method of claim 20, further comprising by using a communications device attempting to communicate with a contact, and said retrieving and deleting temporary information comprising retrieving temporary information from a network, cached memory or remote device to and deleting temporary information from a local calendar of the communications device.

23. The method of claim 22, said using a communications device comprising using a mobile telephone, using a non-mobile telephone, using a computer or using a PDA.

24. A method of scheduling, comprising importing into a calendar a group of information having a given relationship, and providing at least some of such imported information for use, and subsequently removing the imported information from the calendar.

25. The method of claim 24, said providing at least some of such imported information comprising displaying at least some of the imported information in the context of the calendar, and said removing comprising removing all of the imported information that is not associated with a selected date.
